(19) United States
(12) Patent Application Publication
(10) Pub. No.: US 2020/0191327 A1
(43) Pub. Date: Jun. 18, 2020

(54) CORNER MOUNT WARNING SYSTEM

(71) Applicant: Jon Jay Goeders, Kirkwood, MO (US)

(72) Inventor: Jon Jay Goeders, Kirkwood, MO (US)

(21) Appl. No.: 16/223,566

(22) Filed: Dec. 18, 2018

(51) Int. Cl. F16M 13/02; G08B 7/06; G08B 21/22

(52) U.S. Cl. CPC F16M 13/025; G08B 21/22; G08B 7/06

(57) ABSTRACT

A corner mount warning system includes a housing adapted to receive and engage a corner of two perpendicular walls. The housing has a top wall, a bottom wall, an inner side wall, an outer side wall, a first end wall, and a second end wall. Each end wall has a motion detector and at least one warning device. The motion detectors and the at least one warning device are connected to and operated by a control system.

### BACKGROUND OF THE INVENTION

The present invention is directed to a corner mount warning system. More particularly the invention is directed to a system that detects and warns of oncoming traffic from around a corner.

High traffic areas such as hallways in schools, hospitals, offices, hotels, senior care facilities, warehouses, big box stores and the like present potential hazard areas. In particular, at corners, where two perpendicular walls meet, there is a potential for a collision between individuals and/or objects. When individuals alone, or individuals with objects such as equipment carts, wheelchairs, and the like simultaneously reach a corner, where view of oncoming traffic is obscured, there is the potential for a collision, injury, and/or damage to equipment. Accordingly, a need exists in the art for a system that addresses these problems.

An objective of the present invention is to provide a corner warning system to prevent or reduce accidents.

Another objective of the present invention is to provide a corner warning system that is small, lightweight, and low-cost.

A still further objective of the present invention is to provide a corner warning system that improves the efficiency of movement in a busy, fast-paced environment.

These and other objectives will be apparent to those having ordinary skill in the art based upon the following written description, drawings, and claims.

### SUMMARY OF THE INVENTION

A corner mount warning system includes a housing that is adapted to fit about a corner of two perpendicular walls. The housing has a top wall, a bottom wall, an inner side wall, an outer side wall, a first end wall, and a second end wall. Preferably, the inner side wall engages the two walls for its entire length or alternatively engages a mounting plate. The first and second end walls dwell in planes that are perpendicular to one another.

Each end wall has at least one motion detector and at least one warning device. The motion detectors are positioned to detect movement in a traffic pattern adjacent the walls toward the corner. The warning device includes a speaker adapted to produce an audible warning, a blinking light, and/or lights of different colors.

Disposed within the housing is a control system having a processor connected to a power source, the motion detectors, and the warning device. Upon detection of movement torward the corner the motion detector sends a signal to the control system. The control system processes the signal and sends a directive signal to the warning device(s) in the other end wall from the end wall of the motion detector to activate the warning signal(s).

### BRIEF DESCRIPTION OF THE DRAWINGS

FIG. 1 is a top plan view of a corner warning system; and

FIG. 2 is a side sectional view of a corner warning system.

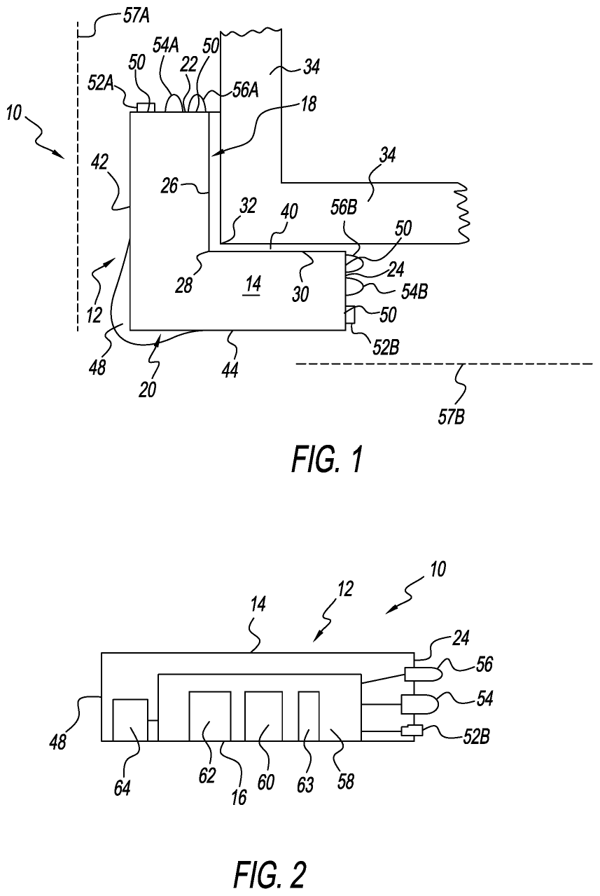

### DETAILED DESCRIPTION

Referring to the figures, a corner mount warning system 10 includes a housing 12 having a top wall 14, a bottom wall 16, an inner side wall 18, an outer side wall 20, a first end wall 22, and a second end wall 24. The inner side wall 18 has a first section 26 that extends from the first end wall 22 to an inner corner 28. A second section 30 of the inner side wall 18 extends perpendicularly in relation to the first section 26 from the corner 28 to the second end wall 24.

The inner side wall 18 is formed to receive and engage a corner 32 of two perpendicular walls 34 and is mounted at the floor, the ceiling, or anywhere in between. The inner side wall 18 is mounted directly to the walls 34 with screws, adhesive, or the like. Alternatively, a mounting plate 40 is mounted to the walls 34 and the inner side wall 18 is mounted to the mounting plate 40.

The outer side wall 20 also has a first section 42 and a second section 44 that are generally perpendicular to one another and extend from the first end wall 22 and the second end wall 24 to an outer corner 46. The outer corner 46 can form a sharp point, or preferably is rounded to prevent injuries. Also, a cover 48 can be made of resilient material such as rubber or the like to prevent damage to the housing 12.

The end walls 22 and 24 have at least one, and preferably a plurality of openings 50 in each. Disposed within the housing 12, and aligned with and extending out of the openings 50 in each end wall 22 and 24, are at least one motion detector 52, at least one light 54, and at least one speaker 56.

At least one motion detector 52 is adjustable and adapted to detect motion in a traffic path 57 adjacent the walls 34. Alternatively, more than one motion detector 52 are used and adapted so that their signals cross along the traffic path 57.

Also disposed within the housing 12, is a control system 58 having a processor 60 that operates software 62 and memory 63. The control system 58 is connected to a power source 64 such as a replaceable or rechargeable battery or an external source such as an electric socket.

The motion detectors 52, lights 54, and speakers 56 are all connected to and operated by the control system 58. In operation, the motion detectors 52A and 52B are positioned to detect motion within the traffic paths 57A and 57B respectively. When motion is detected, the motion detector 52A sends a signal to the control system 58. Using the software 62, the processor 60 activates a warning signal at the end wall opposite the motion detector 52A. The warning signal includes an audio signal through speaker 56, a blinking of one or more of the lights 54, and/or a switch in color of the lights such as from green to red. The intensity of the warning can be intensified, such as a louder audio signal and/or faster flickering of the lights 54 when the system 10 detects motion approaching the corner 32 that is estimated by the control system 58 to arrive at approximately the same time.

Accordingly, a corner mount warning system has been disclosed that, at the very least, meets all the stated objectives.

1. A corner mount warning system, comprising:
a housing having an L-shape extending between a first end wall and a second end wall, wherein the housing is configured to be mounted to a corner;
the first end wall and the second end wall each having a motion detector and at least one warning device; and
a control system disposed within the housing and configured to activate the at least one warning device at one end wall when motion is detected at the opposite end wall.

2. The system of claim 1 wherein the housing has a top wall, a bottom wall, an inner side wall, and an outer side wall.

3. The system of claim 2 wherein the inner side wall has a first section that extends from the first end wall to an inner corner and a second section that extends from the inner corner to the second end wall.

4. The system of claim 2 wherein the outer side wall has a rounded corner.

5. The system of claim 1 wherein the at least one warning device is a speaker adapted to provide an audio signal.

6. The system of claim 1 wherein the at least one warning device is a blinking light.

7. The system of claim 1 wherein the at least one warning device includes two lights having different colors.

8. The system of claim 1 further comprising a mounting plate connected to the housing.

9. The system of claim 1 further comprising the housing having a cover made of a resilient material.

10. The system of claim 9 wherein the cover is made of rubber.

11. The system of claim 1 wherein the first end wall and the second end wall each have an opening and a motion detector extending through the opening, wherein the motion detector is in communication with the control system.

12. The system of claim 2 wherein the control system is configured to intensify the warning device of the first end wall and the warning device of the second end wall when the control system detects motion approaching the outer corner at approximately the same time.
